(19) United States
(12) Patent Application Publication
(10) Pub. No.: US 2005/0223796 A1
(43) Pub. Date: Oct. 13, 2005

(54) "THE SEE LEVEL" An apparatus for monitoring the changing levels of fluid in a preexisting container at a remote location. (An Intelligent Dip Stick)

(76) Inventor: Alan Henry Green, Del Valle, TX (US)

Correspondence Address: ALAN HENRY GREEN, 6101 WOLF LANE, DELVALLE, TX, 78617, US

(21) Appl. No.: 10/709,068

(22) Filed: Apr. 9, 2004

(51) Int. Cl. G01F 23/00

(52) U.S. Cl. 73/290 R

(57) ABSTRACT

A simple, inexpensive, non-mechanical apparatus for monitoring the changing fluid level in a remote pre-existing container, without requiring access to the bottom (of the outside) of the container. Visual display of the level is in 10, 10% increments to full capacity. The 10 increments are available on a connector as data output for process control, if required. The level can be presented as “% Full”, Gallons, Feet, or whatever units are appropriate.

### BACKGROUND OF THE INVENTION

The proposed system is intended to measure, remotely, the changing levels in primarily water-based fluid in an enclosed tank.

Many systems are currently available to provide a display of the level of the liquid in a tank.

U.S. Pat. No. 5,705,747 to Bailey discloses a system and method of displaying a level of a liquid contained in a tank, wherein the level of the liquid is measured using a sensing device and includes a user interface, a processor, and a scaleable graphical display.

This is a complex, sophisticated system intended for a more demanding application requiring elapsed time related data and requires a special tank.

U.S. Pat. No. 3,548,657 to Panerai et al, discloses a system which provides a vertical bar display representative of the level of the liquid using specific optical light-transmitting sensing device. The sensing device includes a plurality of optical reflection prisms simultaneously and uniformly illuminated by a luminous source located on one wall of the tank.

This is a complex, sophisticated system intended for a more demanding application requiring a special and elaborate sensing system pre fitted to the tank.

U.S. Pat. No. 4.987,776 to Koon discloses a storage installation which is capable of storing a variety of free-flowing materials, both conductive and non-conductive, includes a level sensing device which may be disposed either exteriorly or interiorly thereof. The device has either one or a plurality of level sensor and sensor circuit pairs which are preferably disposed vertically within a non-electrically conducting tube which may be hermetically sealed from contact with the stored material. The level sensors comprise respective sensing capacitors, each having effectively a single plate construction. Grounded electrical contacts, if relatively adjacent, may comprise the other side of the effective sensing capacitor. Electrostatic force lines flow outward from the sensing capacitor(s), and are differentially interfered with by the presence or absence of materials or objects to be sensed. Such interference affects the dielectric constant of the respective sensing capacitor, which can in turn be detected to drive a level indicator display.

This is a capacitance sensing system, complex, sophisticated and intended for a more demanding application requiring a special and elaborate sensing system pre fitted to the tank. Also requires an oscillator.

U.S. Pat. No. 4,780,705 to Beane discloses an overfill sensing system uses a capacitive sensor (12) on the interior of a tank for sensing the presence of a liquid to cease the filling process. The capacitive sensor (12) includes a sensing capacitor (16) and a reference capacitor (18) on separate arms of a bridge circuit (22). An oscillator (28) supplies an AC signal to the bridge circuit (22) divided by a variable resistor (30) to balance the bridge (22). A comparator (24) receives the output on each arm of the bridge (22) to sense a differential therebetween. When a liquid reaches the sensing capacitor (16), the capacitance changes from a predetermined capacitance, thereby changing the differential. A control circuit (14) is responsive to the differential at the output of the comparator (24) for visually indicating the status of the filling process and ceasing the filling process from the filling facility when a liquid has been detected.

This is a capacitance sensing system, complex, sophisticated and intended for a more demanding application requiring a special and elaborate sensing system pre-fitted to the tank. Also requires an oscillator.

### BRIEF SUMMARY OF THE INVENTION

It is thus the object of this invention to provide a simple system that fulfills a limited area of utilization. The proposed system provides an inexpensive, simple solution with no moving parts or special sensors and does not require access to the bottom of the tank, as in many cases, the tank is below ground or the problem of possible leaking has to be addressed. Unlike prior systems the invention can be fitted to a preexisting underground tank with limited access to the top of the tank and provides remote display over 300 feet from the tank being monitored. Also, as the invention is unique in its simplicity, it is restricted in its use as follows.
1. The fluid being monitored must have a conductivity greater than 16.3 μS/cm
2. The size of the tank must be known and fixed.
3. The fluid must not adhere excessively to the probe

This eliminates its use for most oil based products but has many applications in the domestic, agricultural and industrial arena as follows:

Successful tests have been carried out using this system with the following fluids:

| | | |
|---|---|---|
| Rain water | Tap-water | Ground water |
| Pond water | Well-water | Swimming pool water |
| Milk | Beer | Wine |
| Ammonia | Bleach | Liquid detergent |
| Liquid fertilizer | Insecticide | Vinegar |
| Waste water | Septic Water | |

See table 3 and 4 for more detailed information.

A pre-calibrated probe specifically designed for the user's application is one of the key design features. The probe was designed to have the maximum invulnerability to problems of contamination encountered by other similar systems. Unfortunately the length of the probe has to be anticipated in accordance with the depth of the levels being measured but can be made available in standard sizes or made to order. The standard 5 foot version is detailed and the changes necessary for a 4 foot version also described All have a standard 1¼ inch plumbing fitting. The system has been tested successfully to lengths over 300 feet and as small as 2 inches on the prototypes. It is anticipated that the users will be using standard sizes so mass production would not be a problem.

The probe consists of 10 conductive plates mechanically placed at 10% increments along the length of the probe. As the fluid level rises and falls successive contact is made to the plates and the remote display is illuminated in 10% increments. Digital data is available.

Other systems are generally more complicated and expensive and prone to failure in a hostile environment. This system is simple, inexpensive to produce, has no moving parts and does not use special sensors or transducers. The display electronics box with its power source can be at least 300 feet away from the measurement point providing true remote operation.

### BRIEF DESCRIPTION OF THE SEVERAL VIEWS OF THE DRAWING

Note: Use the block diagram of FIG. 2 to reference the sub assemblies, their drawings and FIG. Numbers.

FIG. 1 is a diagram of the embodiment of a typical system as used on the prototype and preproduction version. A 5 foot deep, below ground tank was used for this purpose and for making drawings FIG. 3-FIG. 5.

FIG. 2 is a block diagram showing the complete system and its components referencing the appropriate assemblies and their drawings.

FIG. 3 shows the mechanical detail of the integrated assembly. Inner probe, outer sheath, electronics box and interconnecting cables.

FIG. 4 shows the mechanical details of the outer sheath

FIG. 5 shows the mechanical details of the inner probe.

FIG. 6 shows how the design would be changed for the embodiment of a 4-foot deep system.

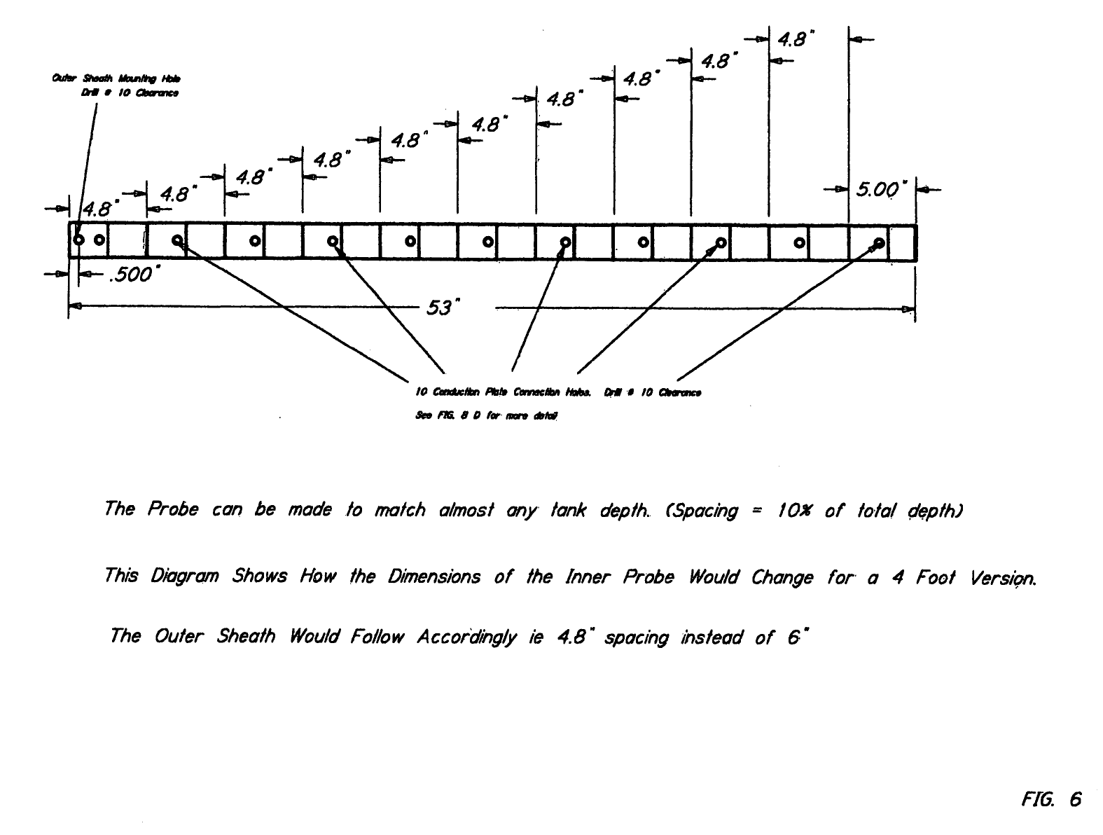

FIG. 7 is a complete electronic schematic of the electronics box.

FIG. 8 shows the detail of the plate connection and associated parts.

FIG. 9 shows the detail of the probe connector assembly 007.

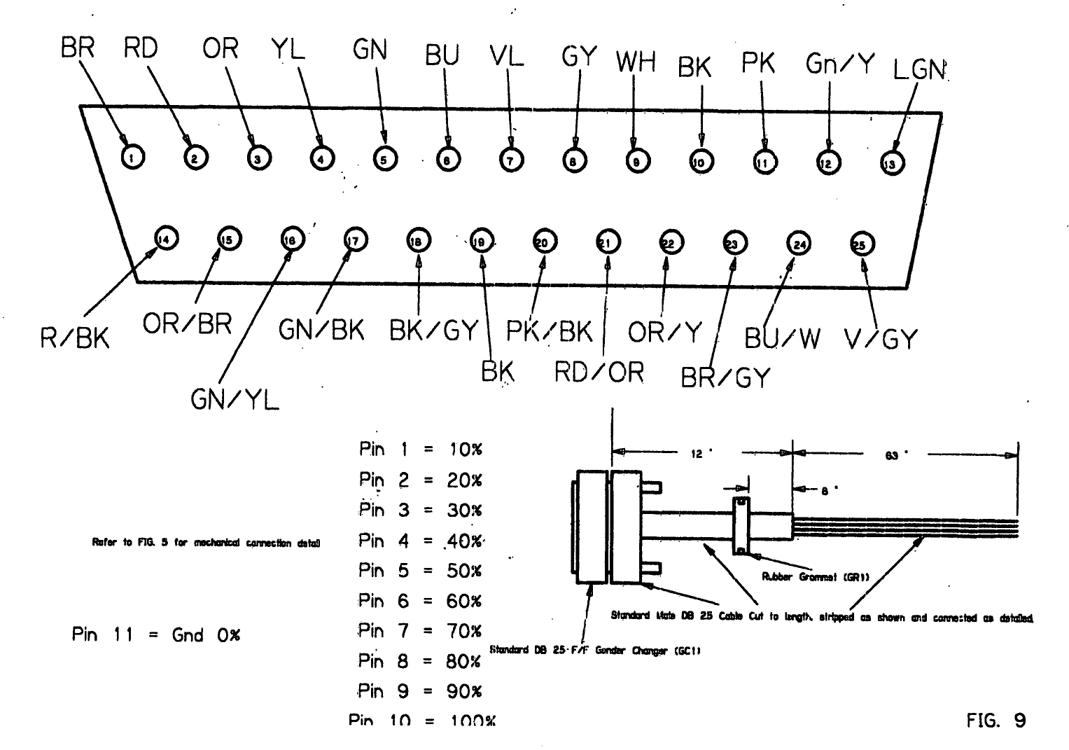

FIG. 10 shows the detail of interconnecting cable assembly 003

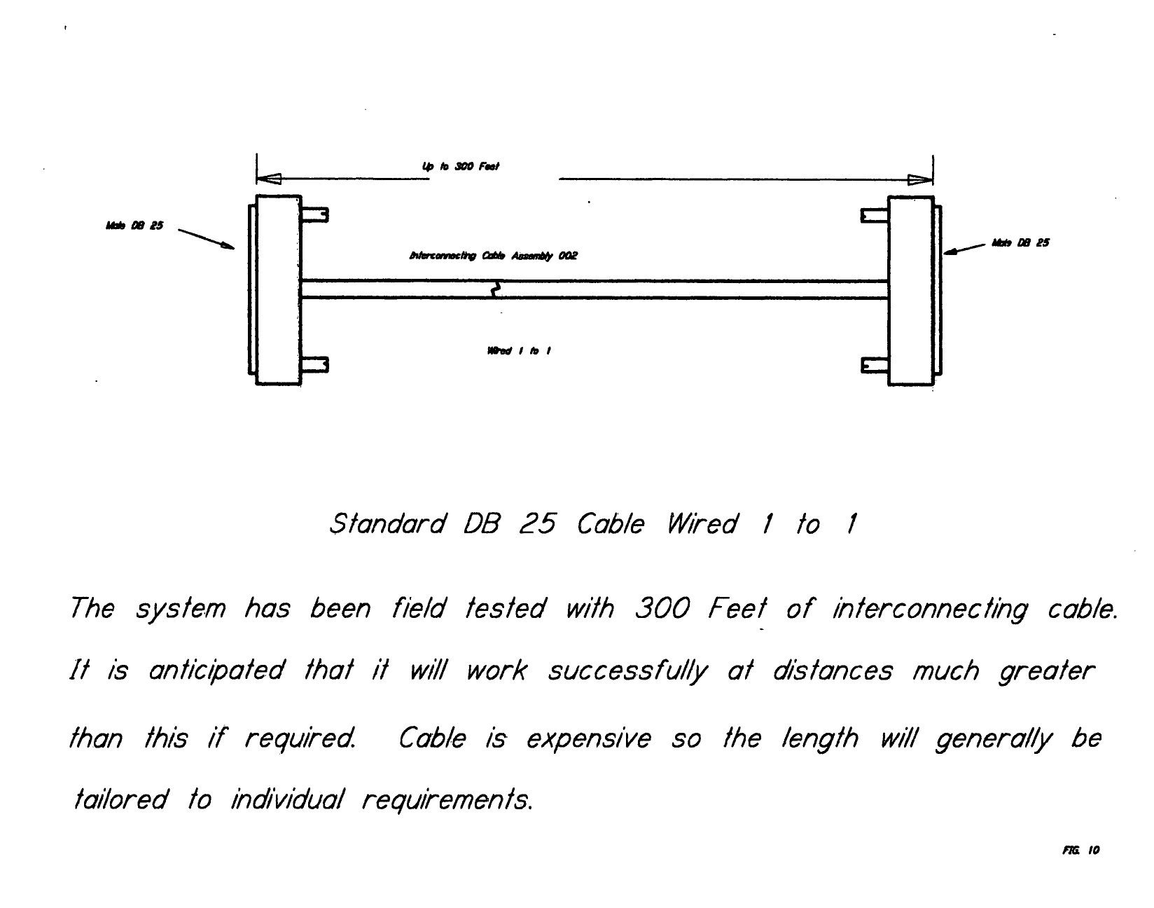

FIG. 11 shows the mechanical assembly of the display electronics box.

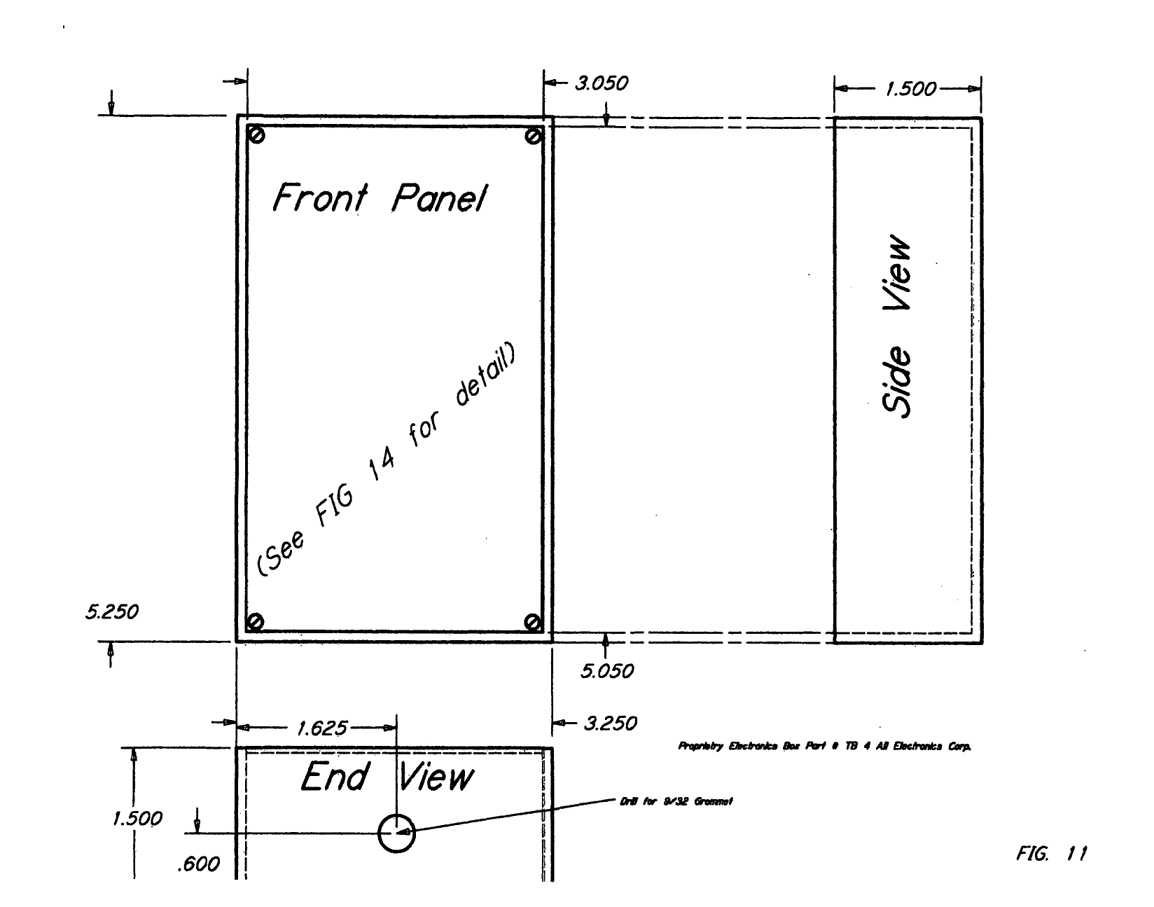

FIG. 12 shows the detail of display electronics box interconnecting cable assembly 004

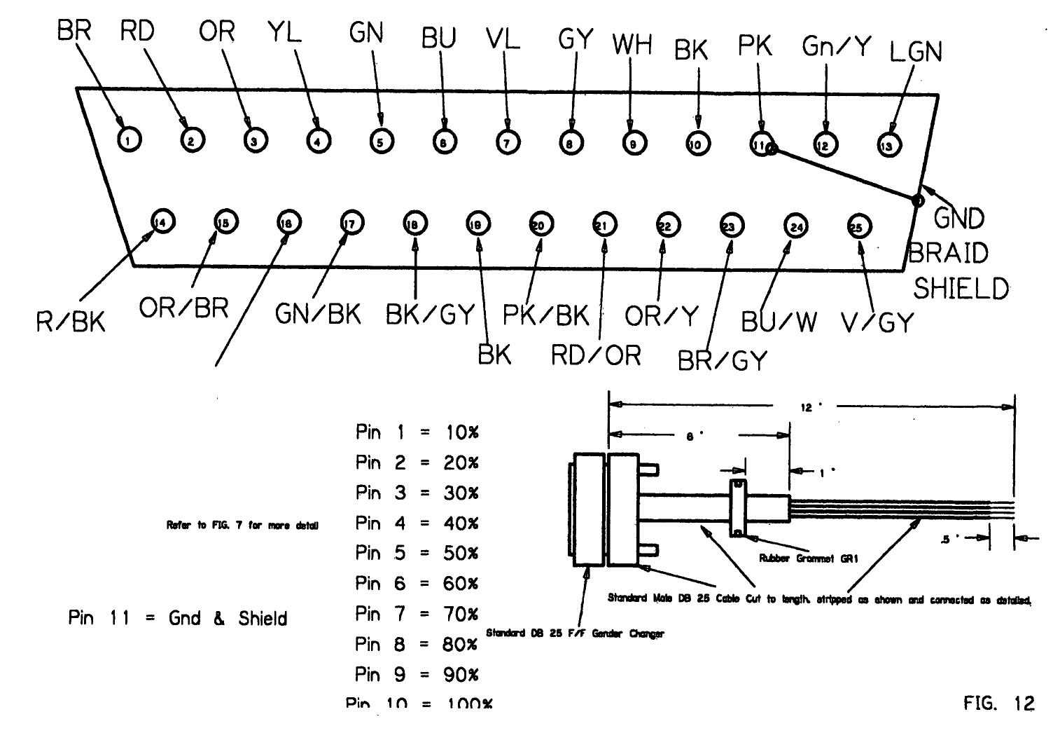

FIG. 13 shows connection detail of Optional Data Output J1.

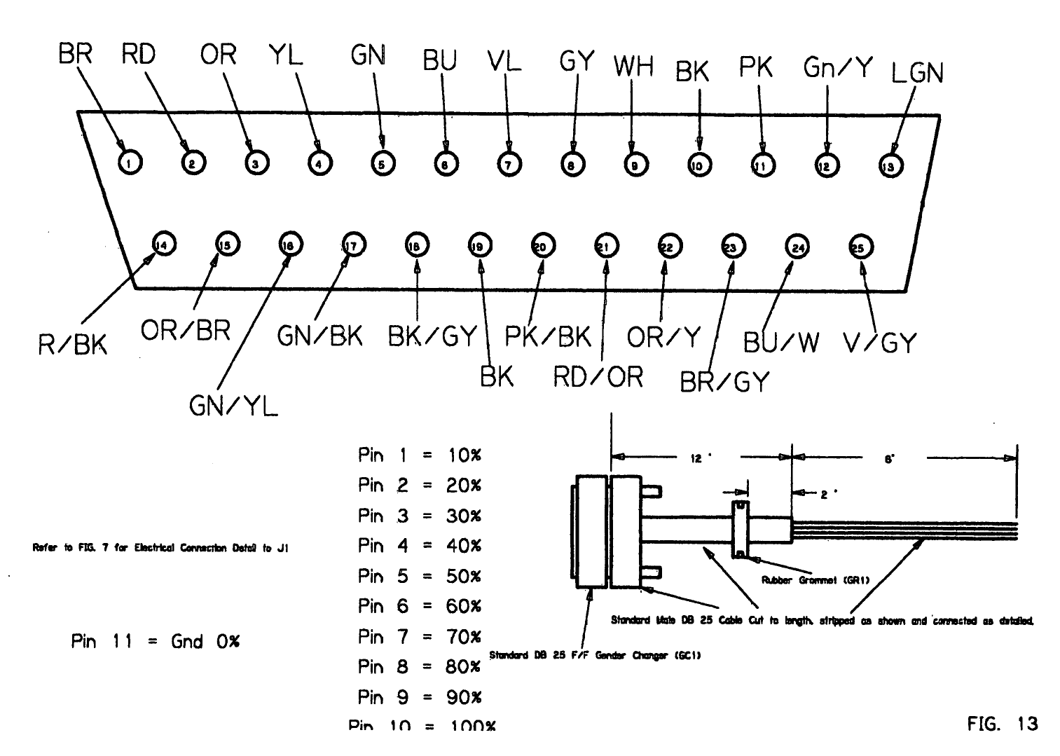

FIG. 14 shows the display electronics box front panel

FIG. 15 shows the drilling data of the front panel.

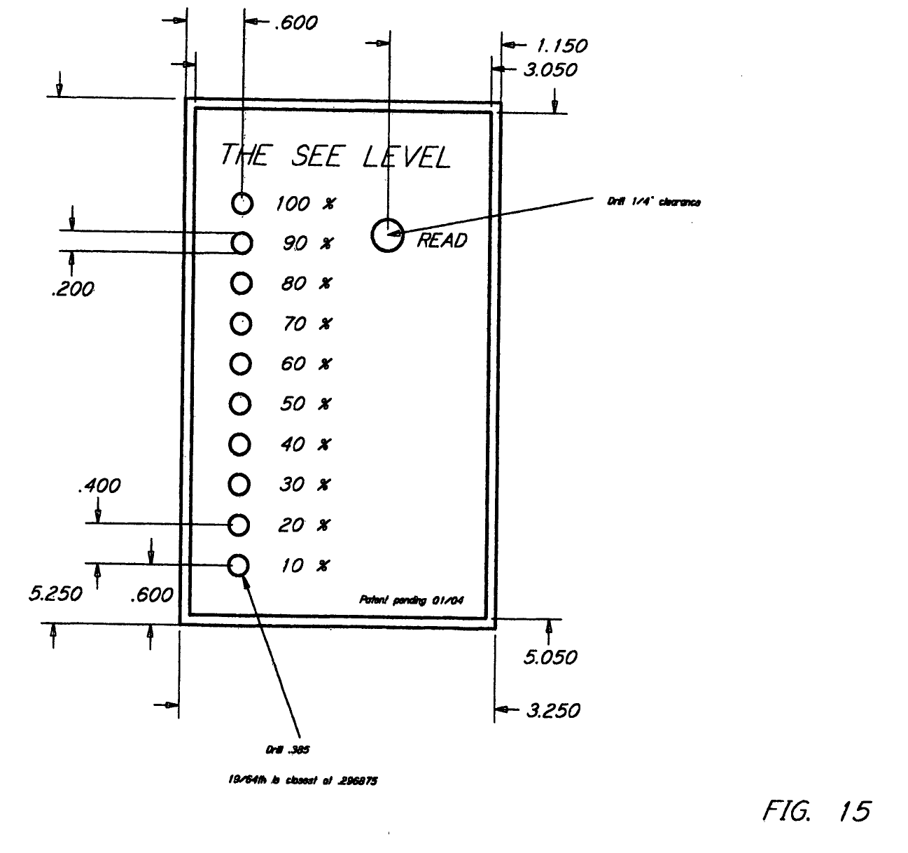

FIG. 16 shows a photograph of the Electronics Display Box pre production version.

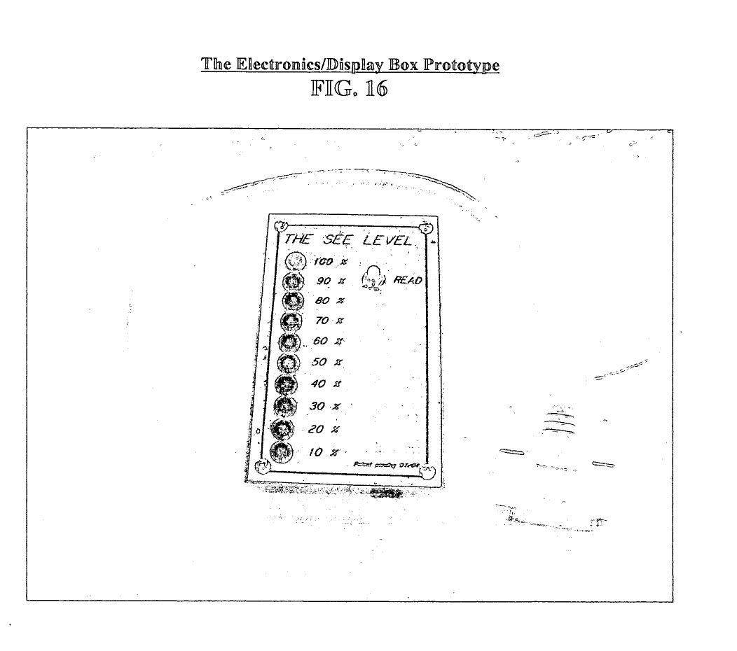

FIG. 17 shows a photograph of the probe assembly (5 foot version).

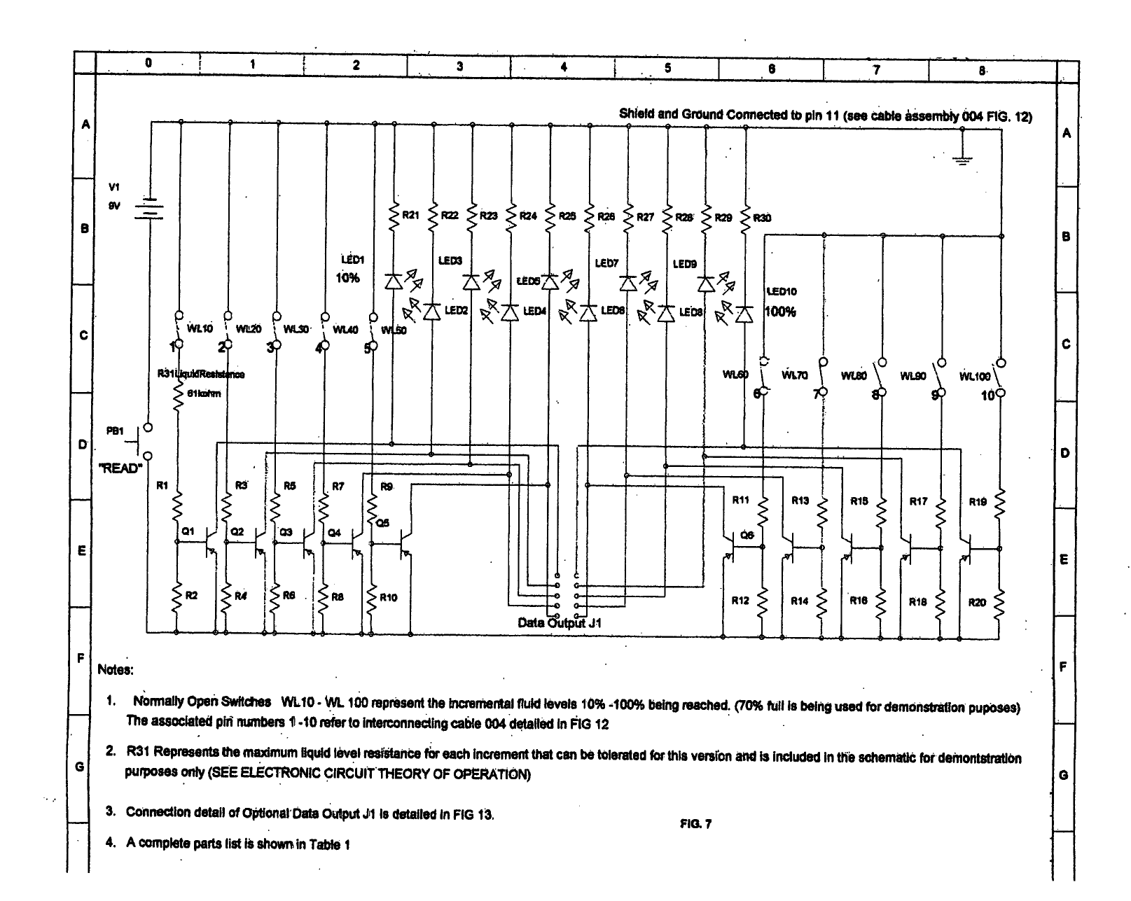

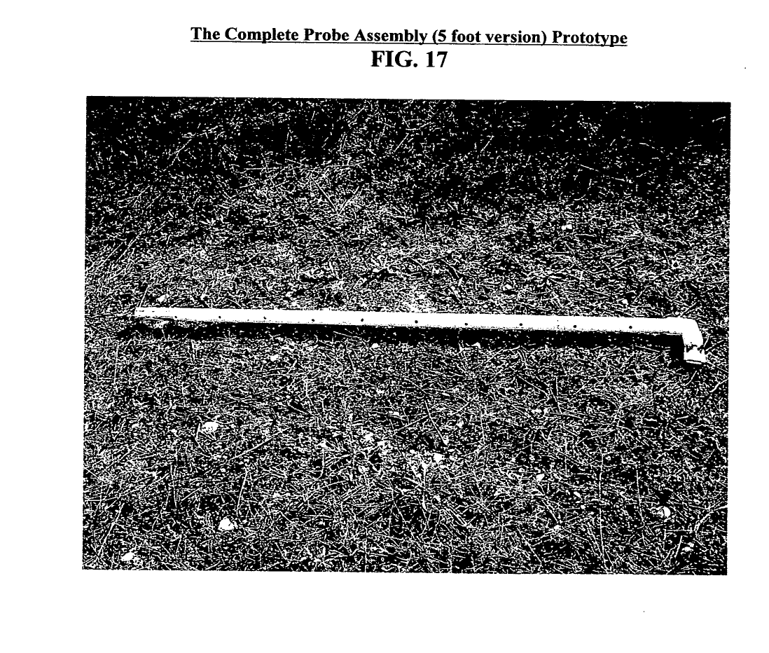

Table 1: A complete parts list of the components illustrated in FIG. 7, & 14 is given in Table 1.

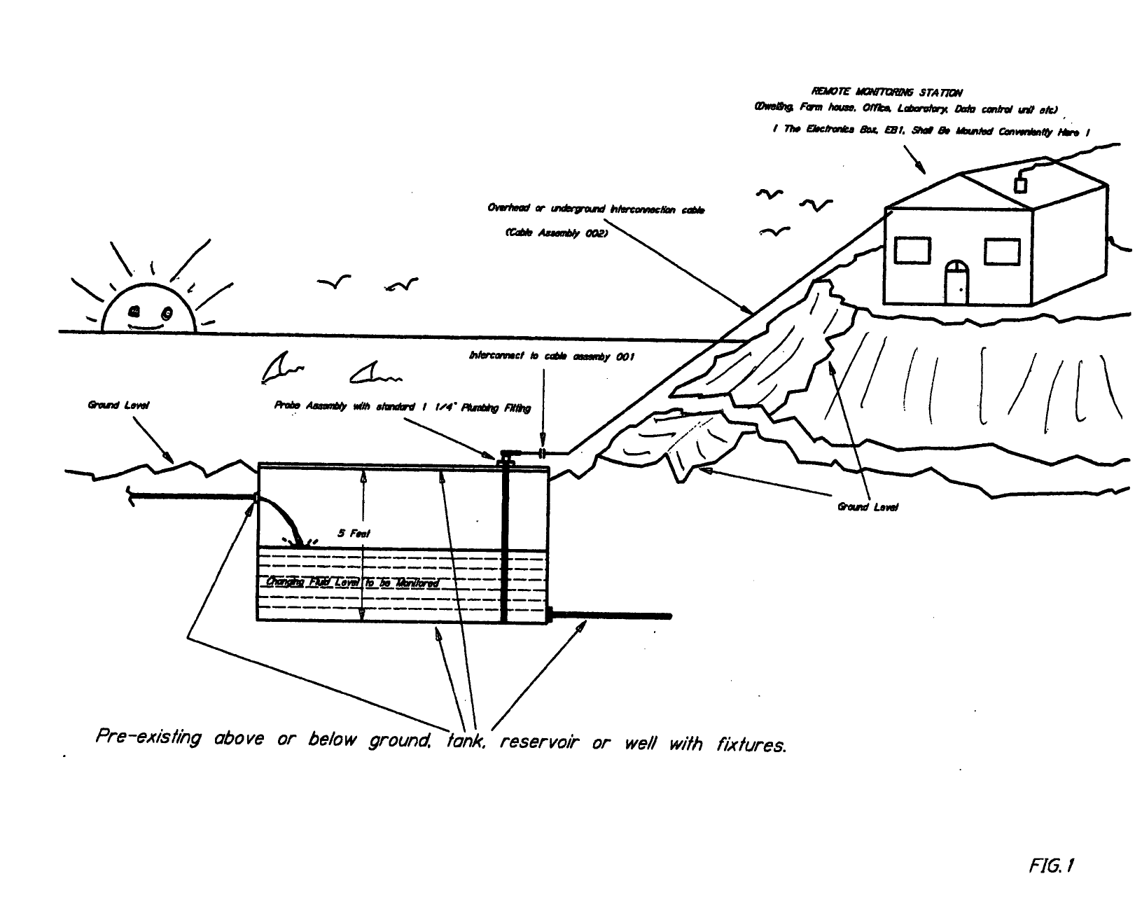

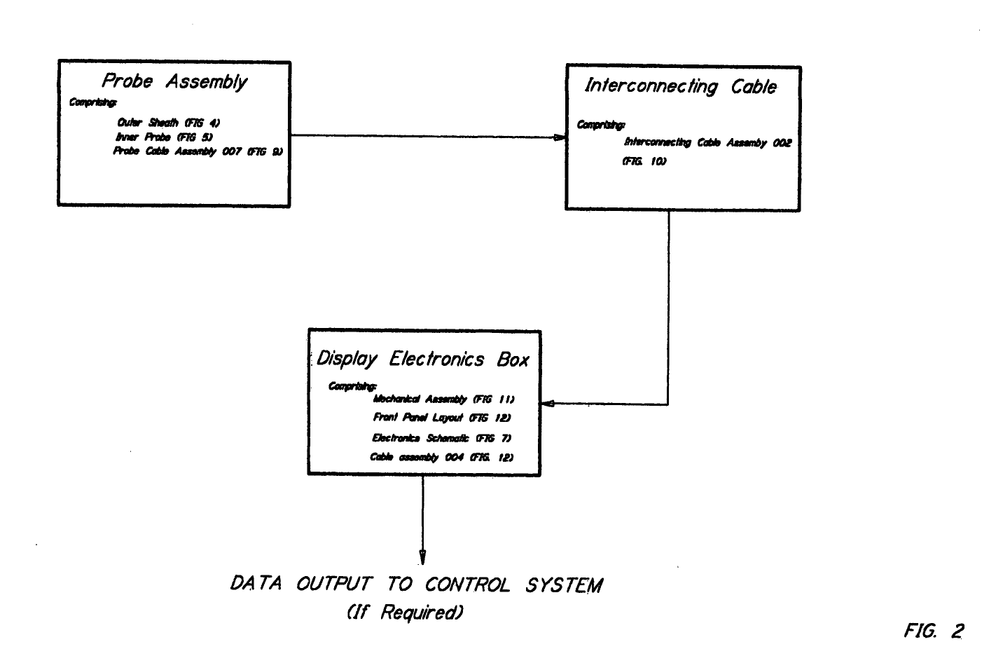

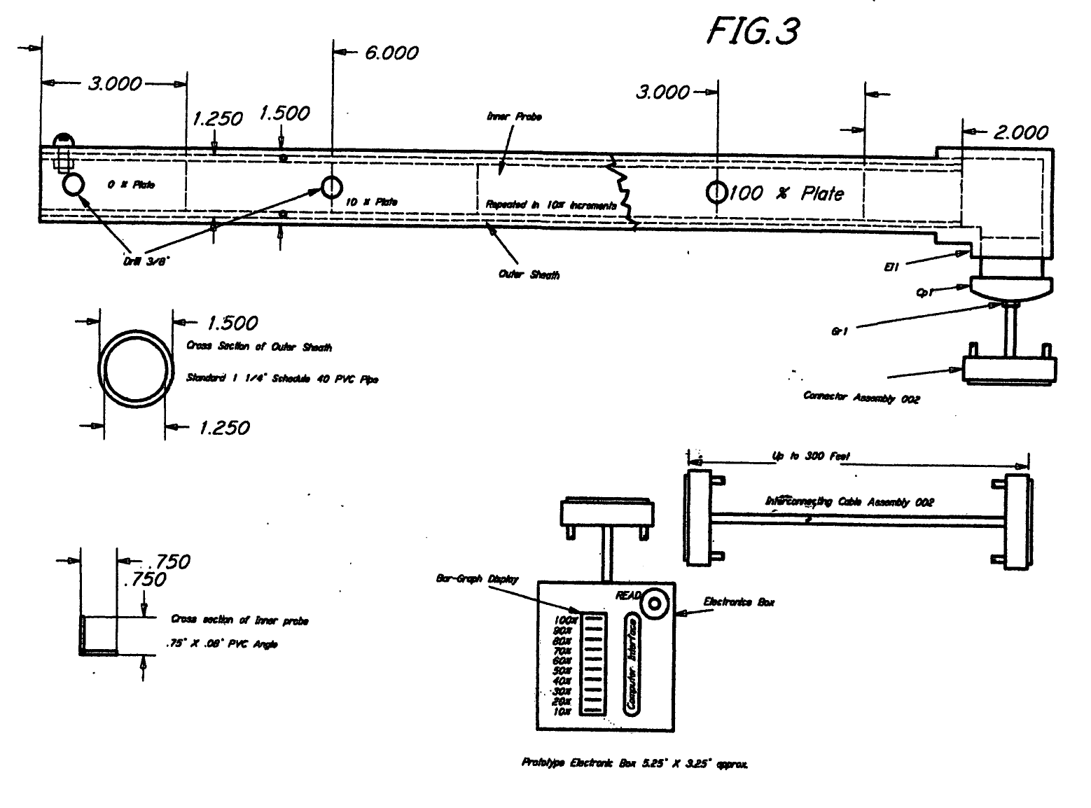

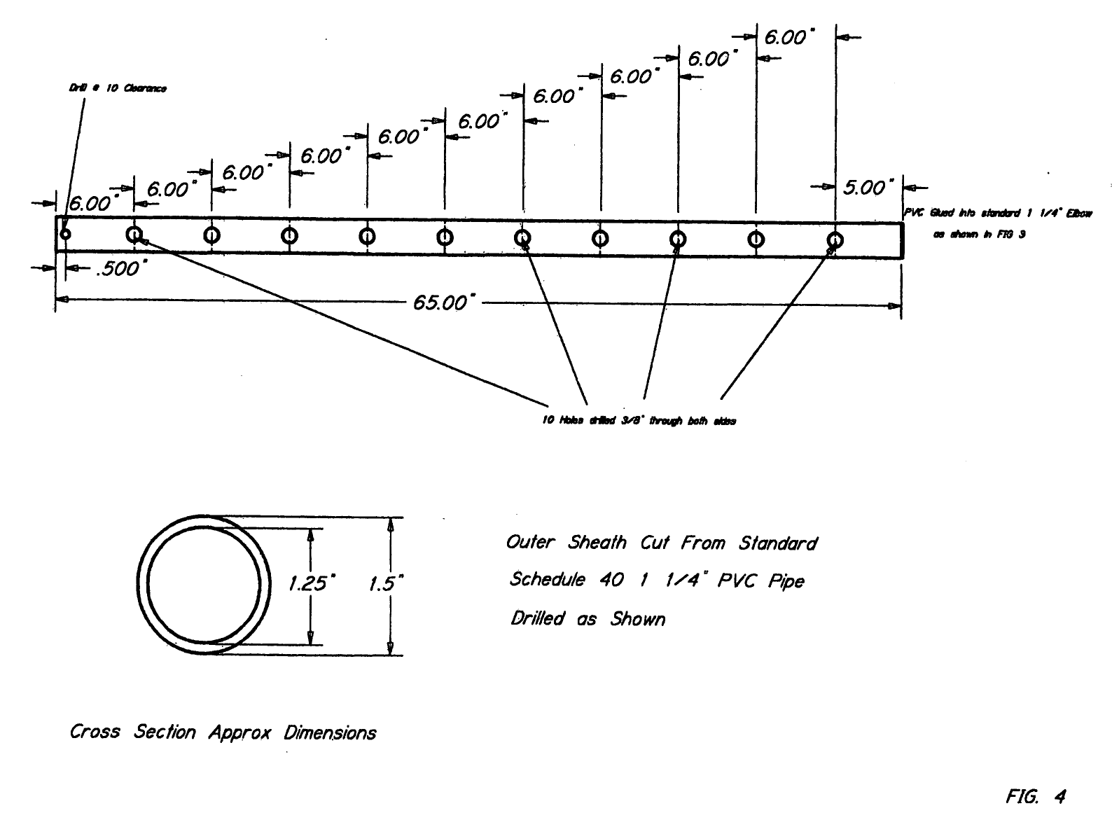

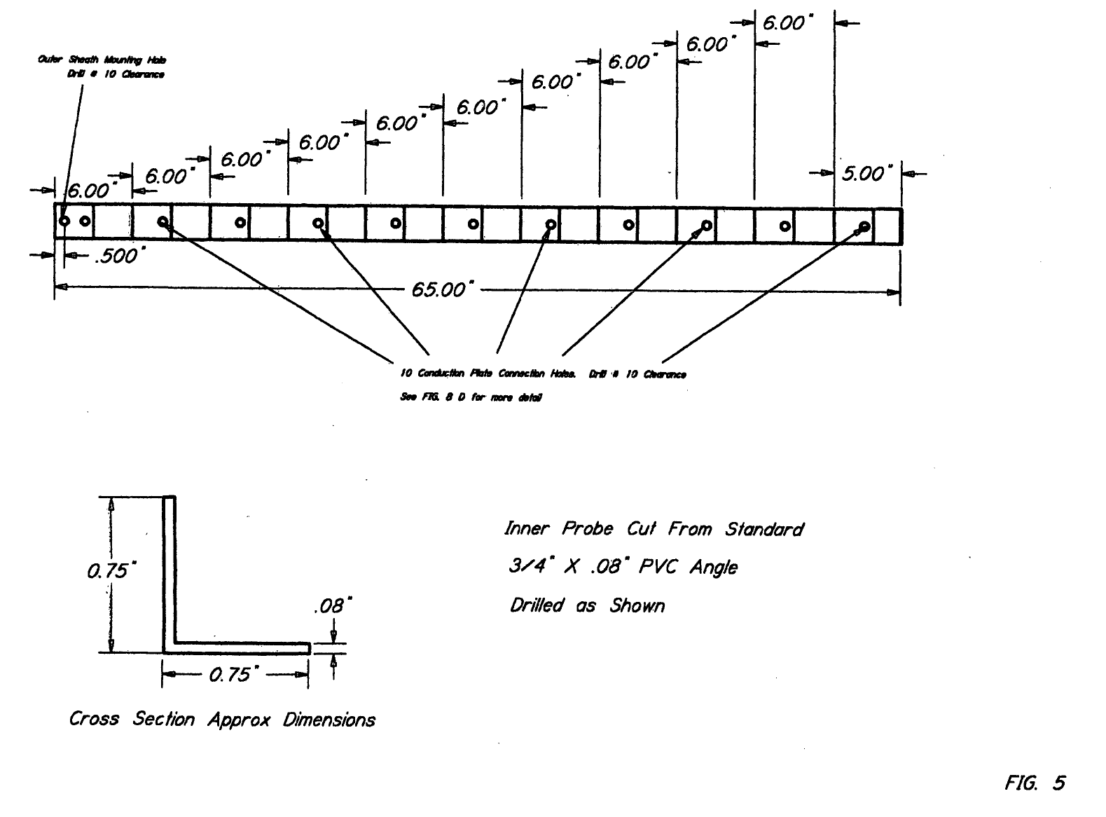

TABLE 2: A complete parts list of the components illustrated in FIG. 1-5 is given in Table 2

TABLE 3: Sample measurements were carried out on common materials to test their compatibility. The results are shown in Table 3.

TABLE 4: Table 4 was included for comparison of some published figures of EC (electrical conductivity) and their respective TDS (Total Dissolved salts) for naturally occurring water.

### DETAILED DESCRIPTION OF THE INVENTION

There are many ways of monitoring the fluid level in a tank ranging from “looking into it”, using a dip stick, a mechanical float system or an external hydraulic eye glass to the most sophisticated computer controlled systems with elaborate sensors. The proposed system provides an inexpensive simple solution with no moving parts, or special sensors and does not require access to the bottom of the tank, as in many cases, the tank is below ground or the problem of possible leaking has to be addressed (See FIG. 1). The power supply and electronics/display box may be 300 feet from the tank being monitored (see FIGS. 1 & 3) and only one electronics/display box is required to serve any number of tanks to be monitored.

The key to reliable operation of the system over and above other systems available, is having a well defined on and off state for the indication of the liquid levels. This requirement was addressed in the design philosophy in the following manner:

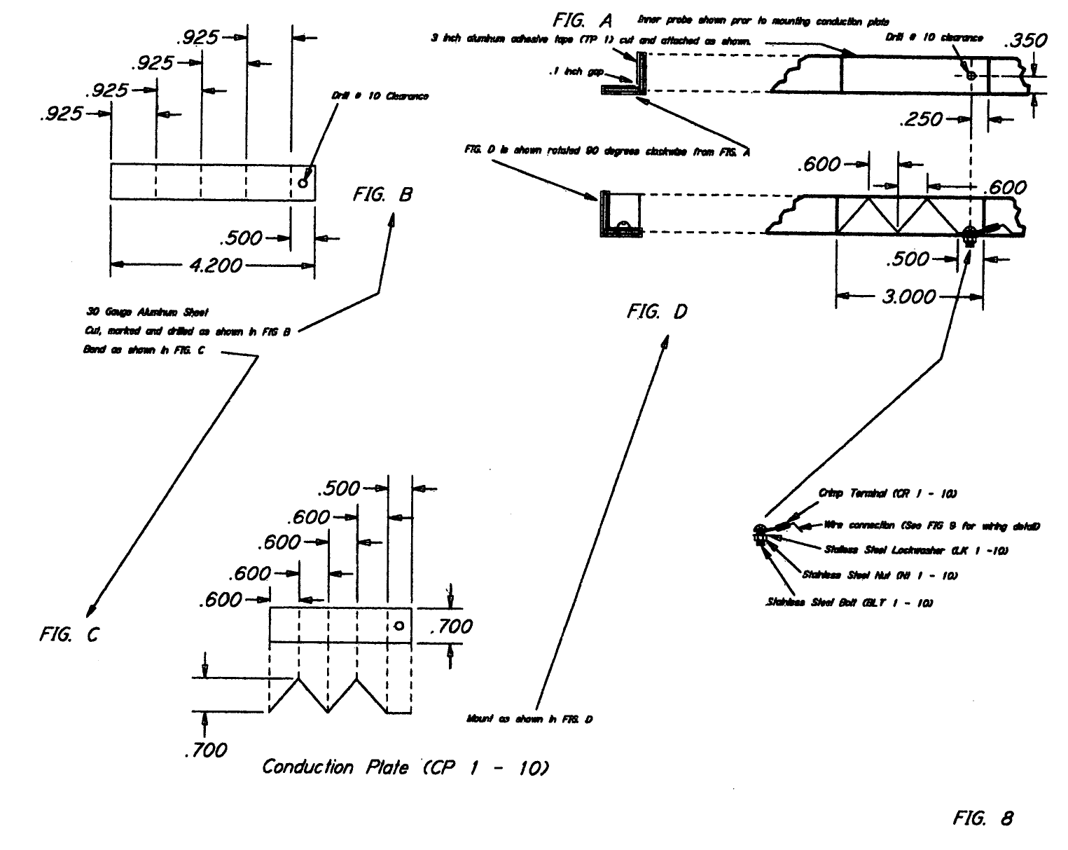

Contamination and malfunction of the measurement sensors or transducers is eliminated by not using small intricate expensive devices at all. Instead, a relatively large surface area (9 square inches) metal plate is used to detect each measurement increment. Details of the plates are shown in FIG. 8.

Further definition of the exact turn on condition is achieved by the choice of the decision making circuits for the indicators in the electronics control box. This important aspect is fully described in the section below labeled “Electronic Circuit Theory of Operation”.

Electronic Circuit Theory of Operation

Refer to electronic schematic FIG. 7:

PB 1 is a normally open push button switch. When a reading is to be taken, PB1 “READ” is pressed LEDs 1 through LED 10 will illuminate in accordance to the fluid level in the vessel 10% through 100%. We shall use the 10 % reading circuit for the purpose of this description and the design is merely repeated for the 20% to 100% circuits.

Q1 is a PNP Bipolar Junction Transistor configured as a “normally off” switch. Under standard conditions the turn on voltage between the base and emitter connection was found to be 0.745 Volts. Normally open switch WL10 and associated series resistance R31 represent the fluid level reaching conducting the 10% plate or not.

NOTE: R31 represents the resistance of the fluid, once contact is made, and is not an actual component but is included, purely for demonstration of the theory of operation.

WL10 will close when the fluid level reaches 10%. R2 was chosen as 6.8 Kohms such that 0.745 Volts or greater would appear at the base of Q1 if R31 was less than 61 Kohms. R21 was chosen to limit the current flowing through LED 1. R1 was included as protection from static, interference and inadvertent shorting of the probe. The values used through out, were determined theoretically using normal electronics design techniques. They were then verified on a computer simulation and proven, with extensive “in the field” experiments to determine the most practical values using standard readily available components.

The actual values of the components will vary considerably with manufacturer's tolerances and the prevailing conditions but extensive experiments have shown the components used, to provide correct performance and the best overall realization under the most demanding conditions.

R31, (representing the resistance of the fluid) will vary considerably depending on the actual fluid being measured. 61 Kohms was used as the worse case scenario in the standard design presented here. Resistance values above this level will not provide reliable operation. It is therefore necessary to equate this value in terms of Electrical Conductivity (EC) for the fluid in question. It is normal to express the EC of fluids in units of μS/cm or derivatives thereof as shown in table 3. The probe design provides a +20% safety factor yielding 16.3 μS/cm as the minimum electrical conductivity of acceptable fluids. Fluids with lower EC values will not work reliably with the standard version of the proposed apparatus. (However R2 may be increased in value to accommodate lower EC values for more specific requirements).

It can be readily seen that the standard apparatus as described will function perfectly on all the common fluids it was claimed to.

The 10 increments of “% Full” are made available as parallel data output at connector J1 (see FIGS. 7 & 13).

A complete parts list of the components illustrated in FIGS. 7, & 14 is given in Table 1

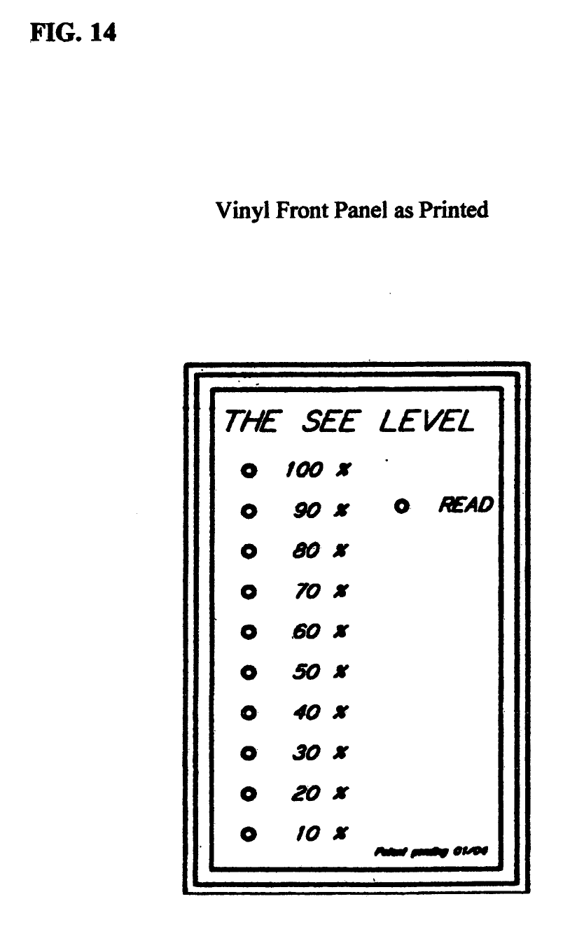

TABLE 1

| REF. No | Part | Description | Qty | Notes |
|---|---|---|---|---|
| R1, 3, 5, 7, 9, 11, 13, | 7001 | 330 Ohm ¼ watt | 20 | |
| 15, 17, 19, 21, 22, | | 5% resistor | | |
| 23, 24, 25, 26, 27, | | | | |
| 28, 29, 30 | | | | |
| R2, 4, 6, 8, 10, 12, | 7002 | 6.8 Kohm ¼ watt | 10 | |
| 14, 16, 18, 20 | | 5% resistor | | |
| LED 1-10 | 7004 | Red LED Everlight 5 mm | 10 | |
| PB 1 | 7005 | Push Button N/O switch | 1 | |
| V1 | 7006 | 9 Volt Battery | 1 | |
| BC1 | 7009 | Battery Clip Connector | 1 | |
| Q1-10 | 7007 | 2N3906 PNP Transistor | 10 | |
| BD 1 | 7008 | Circuit Board | 1 | Wired in accordance with FIG. 7 |
| BX1 | 7010 | Electronics Box | 1 | Part # TB-4 All Electronics Corp |
| FP1 | 7011 | Front Panel | 1 | See FIG. 14 |
| Ancillary Materials | | | | |
| | | Connecting Wire | 6 foot | |
| | | Solder 60/40 | | |

A complete parts list of the components illustrated in FIG. 1-5 is given in Table 2

TABLE 2

| REF. No | Part | Description | Qty | Notes |
|---|---|---|---|---|
| CP1, 2, 3, 5, 6, 7, 8, 9, 10 | 8001 | Conduction Plate | 10 | Fabricated as shown in FIG. 8 |
| CR1, 2, 3, 4, 5, 6, 7, 8, 9, 10 | 8002 | Crimp Terminal | 10 | Ring term #22-#18 wire 8-10 stud |
| LK1, 2, 3, 4, 5, 6, 7, 8, 9, 10 | 8003 | Stainless Steel Lock | 10 | |
| | | Washer # 10 | | |
| NT1, 2, 3, 4, 5, 6, 7, 8, 9, 10 | 8004 | Stainless Steel Nut | 10 | |
| | | # 10 | | |
| BLT1, 2, 3, 4, 5, 6, 7, 8, 9, 10 | 8004 | Stainless Steel Bolt | 10 | |
| | | ½″ # 10 | | |
| GR1, 2 | 8005 | Grommet 9/32ID 9/16 | 2 | Mouser Part # 5167-208 |
| ANG1 | 8006 | PVC angle ¾″ × .08 × 6′ | 1 | |
| CP1 | 8007 | PVC Threaded End | 1 | |
| | | Cap 1¼″ | 1 | |
| EI1 | 8008 | PVC Elbow 1¼″ | 1 | |
| Cable assemblies | 8009 | Standard DB 25 Male to | 1 | Modified in accordance with |
| | | Male Printer Cable | | |
| | | 3″ Aluminum Adhesive | 1 | |
| | | Tape. 6 foot role | | |
| | | PVC adhesive 8 oz | 1 | |

Sample measurements were carried out on common materials to test their compatibility.

TABLE 3
Measurements were made on sample fluids using a proprietary
conductivity meter. The instrument was calibrated using a reference
standard conductivity solution of Potassium Chloride, traceable to NIST
standard reference certified material. Potasium Chloride Calibration
Solution 1413 μS/cm at 25 Degrees C.

| Fluid Material | Conductivity | |
|---|---|---|
| Distilled water | 3 | μS/cm |
| Collected Rain Water | 29 | μS/cm |
| Bottled Drinking Water | 53 | μS/cm |
| Pool Water | 245 | μS/cm |
| Pond water | 395 | μS/cm |
| Chlorinated filtered Farm Tap water | 454 | μS/cm |
| Light Beer | 900 | μS/cm |
| Swimming Pool Water | 1400 | μS/cm |
| 1% Low Fat Milk | 1999+ | μS/cm |
| Orange Juice from Concentrate | 1999+ | μS/cm |
| Guinness Stout | 1999+ | μS/cm |
| Burgundy Wine | 1999+ | μS/cm |
| Black Coffee | 1999+ | μS/cm |
| White Coffee | 1999+ | μS/cm |
| Household Ammonia | 1999+ | μS/cm |
| Dishwashing Detergent | 1999+ | μS/cm |
| Household Bleach | 1999+ | μS/cm |
| Septic tank sample | 1999+ | μS/cm |

As there is such large variance in the solutions and their concentrations these measurements were intended to just give a rough idea of the relative conductivity of various common solutions. All measurements were carried out at approximately 25 Degrees C.

TABLE 4
There follows for comparison some published figures of EC (electrical
conductivity) and their respective TDS (Total Dissolved salts) for naturally
occurring water.
CONDUCTIVITY AND TOTAL DISSOLVED SALT VALUES

| | EC | TDS |
|---|---|---|
| | (μS/cm) | (mg/L) |
| Divide Lake | 10 | 4.6 |
| Lake Superior | 97 | 63 |
| Lake Tahoe | 92 | 64 |
| Grindstone Lake | 95 | 65 |
| Ice Lake | 110 | 79 |
| Lake Independence | 316 | 213 |
| Lake Mead | 850 | 640 |
| Atlantic Ocean | 43,000 | 35,000 |
| Great Salt Lake | 158,000 | 230,000 |
| Dead Sea | ? | ˜330,000 |

1. A method of monitoring the level of fluid in a tank with no mechanical moving parts at a remote inaccessible location, providing, digital readout on a bar-graph display and data output for process control if required:

2. A method according to claim 1 wherein the system will operate in a remote location from a standard 9 Volt 500 mH battery for over two years with normal use or powered from a standard power source if available.

3. A method according to claim 1 where the probe may be custom made to individual requirements and the “read out” displayed in gallons, feet, or whatever units are appropriate. The electronic box may be made an integral part of the probe assembly or connected to the probe via a standard DB25 cable in excess of 100 feet if required.

4. A method according to claim 1,2 and 3 wherein the cost of production would be inexpensive.
